(19) United States
(12) Patent Application Publication
(10) Pub. No.: US 2007/0256099 A1
(43) Pub. Date: Nov. 1, 2007

(54) Digital television receiver and method for processing a digital television signal

(75) Inventors: Chang Sik Yun, Daejeon (KR); Kyung Mee Lee, Seoul (KR)

Correspondence Address: MCKENNA LONG & ALDRIDGE LLP, 1900 K STREET, NW, WASHINGTON, DC, 20006, US

(73) Assignee: LG. Electronics, Inc., Seoul (KR)

(21) Appl. No.: 11/790,891

(22) Filed: Apr. 27, 2007

(30) Foreign Application Priority Data
Apr. 28, 2006 (KR) 10-2006-0038985

(51) Int. Cl. H04N 5/445

(52) U.S. Cl. 725/38

(57) ABSTRACT

A method of processing a digital television signal in a digital television receiver, the method includes receiving a digital television signal including a streaming text table carrying streaming text data representing additional information tramsmitted from a transmitter; parsing the streaming text table, the parsed streaming text table including display information specifying an information type, display time, and display channel associated with the streaming text data; and displaying the streaming text data according to the display information.

This application claims the benefit of Korean Patent Application No. 10-2006-0038985, filed on Apr. 28, 2006, which is hereby incorporated by reference as if fully set forth herein.

### BACKGROUND OF THE INVENTION

1. Field of the Disclosure

The present disclosure relates to a digital television (DTV) receiver and a method for processing the DTV signal.

2. Background

Digital television (DTV) receivers which are currently used in North America and Korea receive channel information from a broadcasting station and provide the channel information to viewers on the basis of the Program and System Information Protocol (PSIP) established in Advanced Television System Committee (ATSC).

The PSIP contains time information, channel number information, and electronic program guide (EPG) information of each channel. Thus, on the basis of such basic information, a variety of functions including a reservation recording function using a personal video recorder (PVR) can be used.

However, as the interest of users for a DTV receiver has increased, the requirement for a variety of convenient functions has also increased. That is, a method for transmitting a variety of additional information as well as broadcast information (video and audio) transmitted basically is required.

### SUMMARY

Accordingly, the present disclosure is directed to a digital television (DTV) receiver and a method for processing a DTV signal that substantially obviate one or more problems described above.

For example, the disclosure may disclose a DTV receiver and a method for processing a DTV signal, by which streaming text table may be displayed streaming text data a user.

Advantages, objects, and features of the invention in part may become apparent in the description which follows and in part may become apparent to those having ordinary skill in the art upon examination of the following or may be learned from practice of the invention. The objectives and other advantages of the various embodiments of the invention may be realized and attained by the structures and processes described in the written description, in the claims, and in the appended drawings.

To achieve these objects and other advantages and in accordance with the purpose of the invention, as embodied and broadly described herein, a method includes receiving a digital television signal including a streaming text table carrying streaming text data representing additional information transmitted from a transmitter; parsing the streaming text table, the parsed streaming text table including display information specifying an information type, display time, and display channel associated with the streaming text data; and displaying the streaming text data according to the display information.

In another aspect, a digital television receiver includes a tuner arranged to receive a digital television signal; a demodulator arranged to demodulate the digital television signal; a demultiplexer arranged to demultiplex a streaming text table from the demodulated digital television signal including the streaming text table carrying streaming text data representing additional information transmitted from a transmitter; a decoder arranged to parse the streaming text table, the parsed streaming text table comprising display information specifying an information type, display time, and display channel associated with the streaming text data; a display unit arranged to display the parsed streaming text data according to the display information; and a controller arranged to control operation of the decoder and the display unit.

It is to be understood that both the foregoing general description and the following detailed description are exemplary and explanatory and should not be construed as limiting the scope of the claims.

### BRIEF DESCRIPTION OF THE DRAWINGS

The accompanying drawings, which are included to provide a further understanding of the disclosure are incorporated in and constitute a part of this application. The drawings together with the description serve to explain the principle of the invention. In the drawings:

FIG. 1 is an exemplary diagram of bit stream syntax for streaming text table;

FIGS. 2A to 2C are an exemplary diagram of setting a streaming text of each channel by combining the information for identifying a streaming text and channel information;

FIG. 3 is a block diagram of an exemplary digital television receiver for processing a digital television signal containing a streaming text table; and

FIG. 4 is an exemplary flowchart of a method for processing a digital television signal.

### DETAILED DESCRIPTION

Reference will now be made in detail to the preferred embodiments of the present invention, examples of which are illustrated in the accompanying drawings. In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used, but by the meanings of each term lying within.

Hereinafter, a digital television (DTV) receiver and a method for processing a DTV signal including streaming text data will be described.

Hereinafter, the term “streaming text data” described herein indicates a variety of additional information necessary for a user, except for broadcast information provided basically, such as audio/video, and is serial encoding data composed of characters or symbols. Accordingly, the DTV receiver must process and provide additional information, such as news or weather information, transmitted to a user in the form of streaming text data.

In general, the streaming text data of the additional information was transmitted/received using an analog vertical blanking interval (VBI) channel. Accordingly, in analog broadcasting, a variety of necessary additional information such as news caption, weather, and stock quotes is transmitted/received by the above-described transmission method.

Hereinafter, the transmission/reception of the streaming text data in digital broadcasting will be described. In the present disclosure, for example, program and system information protocol (PSIP) information will be described.

In the PSIP, broadcasting information, time information and EPG information are transmitted in a form of table. In the transmission/reception of the streaming text data using the PSIP, an example of transmitting the streaming text data in a form of table or descriptor of a predefined table will be described. At this time, a table for transmitting/receiving streaming text data is called a streaming text table.

Hereinafter, a method and apparatus for processing a DTV signal containing the streaming text data will be described in detail with reference to the accompanying drawings.

(1) Digital Television Signal Containing Streaming Text Data

Hereinafter, the streaming text table for transmitting/receiving the streaming text data, which is one of PSIP tables, will be described.

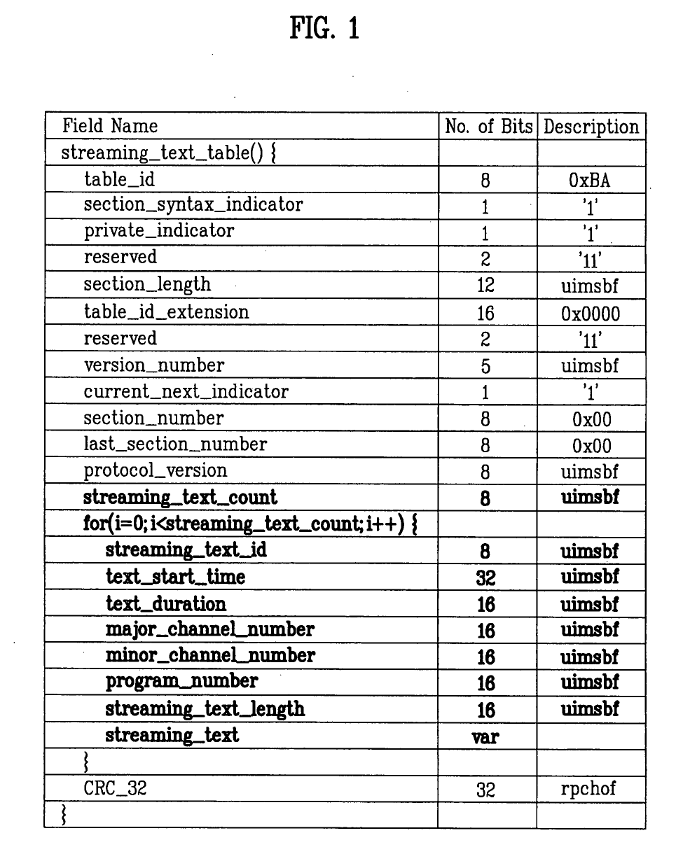

FIG. 1 is an exemplary diagram of bit stream syntax for streaming text table.

The streaming text table may include information for identifying a streaming text, display time and display channel information for displaying streaming text data, and actual streaming text data information.

The streaming text table may be defined in the same form as the other PSIP tables. That is, the streaming text table contains one or more sections. Each section obtained by combining data structures is divided into a header containing a common form, a message body containing actual data recorded therein according to the purpose of each table section, and a trailer containing information for error checking and correction of the table section. In the streaming text table, the header contains a “table_id” field to a “protocol_version” field, the message body contains a “streaming_text_count” field to a “streaming_text( )” field, and the trailer contains a “CRC_{—}32” field.

The structure of the streaming text table section will be described in order of the header to the trailer. For convenience of description, English expressions of fields are used without alteration, but are marked by double quotation marks.

First, the header will be described.

A “table_id” is an 8-bit field which should be set to 0xBA, identifying this table as the streaming text table. A “section_syntax_indicator” is a 1-bit field which should be set to ‘1’. It denotes that the section follows the generic section syntax beyond the section length field. A “private_indicator” is a 1-bit field which should be set to ‘1’. A “section_length” is a 12-bit field specifying the number of remaining bytes in this section immediately following the section_length field up to the end of the section. The value of the section_length should be no larger than 4093.

A “table_id_extension” is a 16-bit field that should be set to ‘0x0000’. A “version_number” is a 5-bit field that is the version number of the streaming text table. The version number should be incremented by 1 modulo 32 when any field in the table_types defined in the loop below or the STT itself changes. A “current_next_indicator” is a 1-bit indicator that is always set to ‘1’ for the streaming text table section; the streaming text table sent is always currently applicable. A “section_number” is an 8-bit field that should always be ‘0x00’ (this table is only one section long). A “last_section_number” is the value of this 8-bit field should always be ‘0x00’. A “protocol_version” is an 8-bit unsigned integer field whose function should be to allow, in the future, this table type to carry parameters that may be structured differently than those defined in the current protocol. At present, the only valid value for protocol_version is zero. Non-zero values of protocol_version may be used by a future version of this standard to indicate structurally different tables.

Next, the message body will be described.

A “streaming_text_count” is a field that counts one or more streaming texts transmitted through a streaming text table section. The information on the streaming text in a loop structure is defined according to the count number of the one or more streaming texts.

Hereinafter, the loop structure of the “streaming_text_count” field will be described. The loop structure may include at least one of information for identifying a streaming text, information on a display start time and duration of the streaming text, information on the channel for broadcasting the streaming text, and streaming text information.

A “streaming_text_id” field is identifier information for identifying the streaming text. An information type of the streaming text can distinguish using the identifier information. For example, the type of the streaming text may distinguish as Table 1.

TABLE 1

| Field Value | Type |
|---|---|
| 0x01 | Advertisement |
| 0x02 | Stock information |
| 0x03 | Weather information |
| . . . | . . . |
| 0xff | Reserved |

The information type of the streaming text is an advertisement if the value of the “streaming_text_id” field is ‘0x01’, is stock information if the value of the “streaming_text_id” field is ‘0x02’, and is weather information if the value of the “streaming_text_id” field is ‘0x03’. Table 1 shows an example of distinguishing the streaming text.

The “streaming_text_id” field can prevent the message overlapping of the transmitted/received streaming texts. The message overlapping indicates that the same streaming text is displayed through the same channel. The message overlapping can be prevented by combining the “streaming_text_id” field and channel information fields such as a “major_channel_number” field, a “minor_channel_number” field, and a “program_number” field.

Next, the streaming text data may be necessary for a user at a specific time but unnecessary for the user after the specific time. Accordingly, a display time associated with the streaming text data may be defined. At this time, the information on the display time may be divided into a display start time of the streaming text data and a duration indicating how long the display of the streaming text data is maintained from the start time. Referring to FIG. 1, the information on the start time of the streaming text data is defined in a “text_start_time” field and the duration is defined in a “text_duration” field.

The “text_start_time” is a 32-bit unsigned integer quantity representing the start time of the streaming text as the number of global positioning system (GPS) seconds since 00:00:00 UTC, Jan. 6, 1980. In any virtual channel, the text_start_time value of a streaming text should not be less than the end time of the preceding streaming text, where the end time of a streaming text is defined to be equal to that streaming text's text_start_time value plus that streaming text's length_in_seconds value. The “text_duration” is a 16-bit field which should be set to seconds.

In information on a channel for displaying the streaming text data, the streaming text data provided together with specific broadcasting contents is useful for a viewer. For example, when news is broadcasted, a caption for news contents is displayed. Hereinafter, a display channel associated with the streaming text data may be represented using the “major_channel_number” field, the “minor_channel_number” field, and the “program_number” field. At this time, each of the above-described fields has 16 bits.

The “major_channel_number” is a 16-bit number that represents the “major” channel number associated with the virtual channel being defined in this iteration of the “for” loop. Each virtual channel should be associated with a major and a minor channel number. The major channel number, along with the minor channel number, acts as the user's reference number for the virtual channel. The major_channel_number should be between 1 and 99. The value of the major_channel_number field should be set such that in no case is a pair of major_channel_number and minor_channel_number duplicated within the streaming text table.

The “minor_channel_number” is a 16-bit number in the range 0 to 999 that represents the “minor” or “sub”-channel number. This field, together with major_channel_number, performs as a two-part channel number, where minor_channel_number represents the second or right-hand part of the number. When the service_type is analog television, the minor_channel_number should be set to 0. Services whose service_type is either digital broadcasting should use minor numbers between 1 and 99. The value of minor_channel_number should be set such that in no case is a pair of major_channel_number and minor_channel_number duplicated within the streaming text table. For other types of services, such as data broadcasting, valid minor virtual channel numbers are between 1 and 999.

In each of the above-described fields, a channel for displaying the transmitted streaming text data may be defined using the pair of major channel number and minor channel number. The functions of the above-described fields can increase by a variety of combinations. For example, when both the major channel number and the minor channel number are ‘0’, it may be defined that all the virtual channels in a current physical channel display a specific transmitted streaming text. When only the minor channel number is ‘0’, it may be defined that, among the virtual channels in the current physical channel, only channels having a corresponding major channel number display the streaming text. When only the minor channel number is ‘0’, it may be defined that, among the virtual channels in the current physical channel, only channels having a corresponding minor channel number display the streaming text. When both the major channel number and the minor channel number are not ‘0’, it may be defined that, among the virtual channels in the current physical channel, a channel having a corresponding major, and the minor channel number displays the streaming text.

A program number may be used independent of, or together with, the major channel and the minor channel. That is, a program for displaying the streaming text may be defined using the program number having the major channel number and the minor channel number.

A “program_number” is a 16-bit unsigned integer number that associates the virtual channel defined herein with the MPEG-2 program association and transport stream (TS) program map tables. For virtual channels representing analog services, a value of ‘0xFFFF’ should be specified for the program_number. For inactive channels (those not currently present in the TS), the program_number should be set to zero. This number should not be interpreted as pointing to a program map table entry.

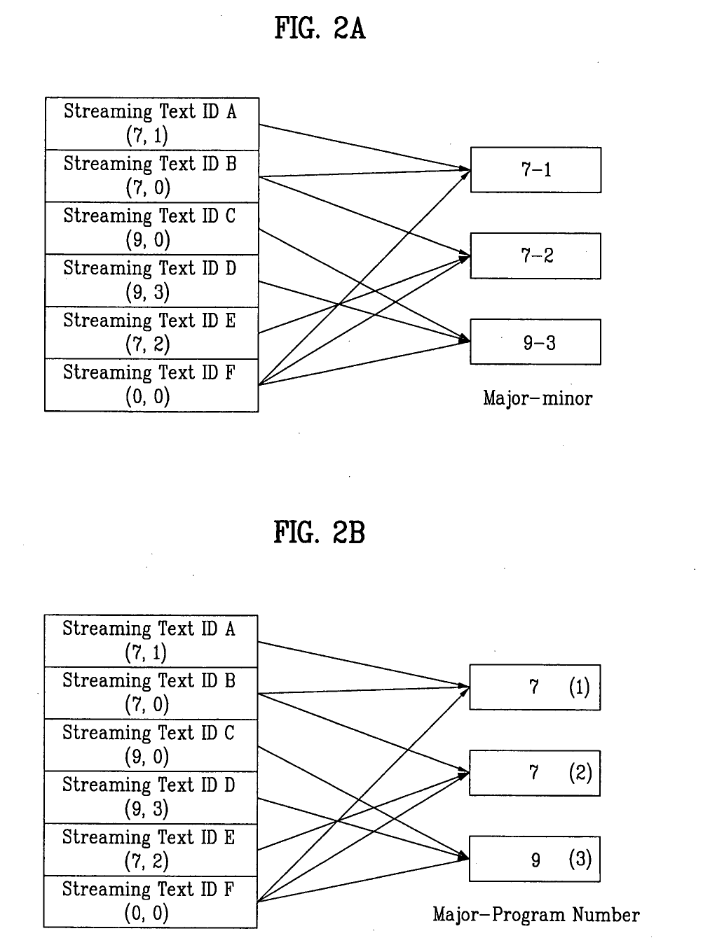

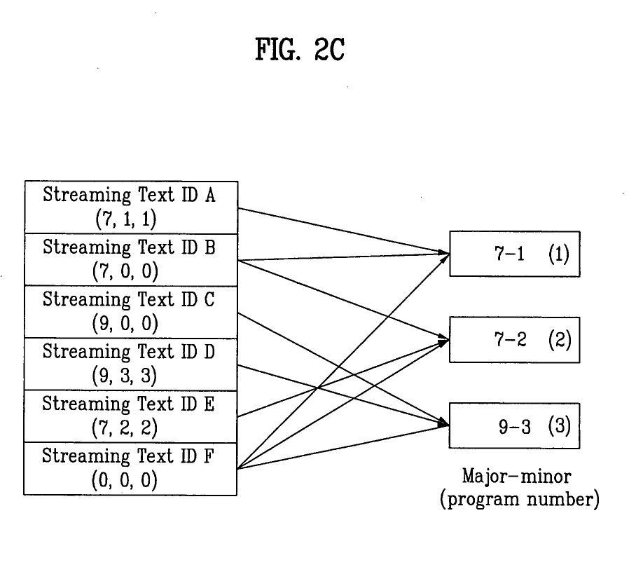

An example of the above-described contents will be described. FIGS. 2A to 2C are an exemplary diagram of setting a streaming text of each channel by combining the information for identifying a streaming text and channel information.

A single streaming text table can transmit streaming texts through several virtual channels in a single physical channel.

For the transmission of the streaming texts, a variety of methods may be used. Hereinafter, a case of using the major channel number and the minor channel number (FIG. 2A), a case of using the major channel number and the program number (FIG. 2B), and a case of using all the major channel number, the minor channel number and the program number (FIG. 2C) will be described.

Referring to FIGS. 2A to 2C, streaming text identifications (IDs) A to F transmitted by a single streaming text table are located at the left side and the major channel number, the minor channel number and the program number are located at the right side. Each streaming text ID contains at least one of the major channel number, the minor channel number and the program number for displaying the streaming text.

A channel for displaying each streaming text will be described with reference to FIG. 2A. In FIG. 2A, the major channel number and the minor channel number are combined in order to provide information on the channel for displaying each streaming text data.

Streaming text data having a streaming text ID “A” has (7, 1), in which a number ‘7’ represents the major channel number and a number ‘1’ represents the minor channel number. That is, it can be seen that a virtual channel 7-1 in a physical channel displays the streaming text data having the ID “A”.

Streaming text data having a streaming text ID “B” has (7, 0), in which a number ‘7’ represents the major channel number and a number ‘0’ represents the minor channel number. At this time, the minor channel number is ‘0’, which represents that, among the virtual channels in the physical channel, only channels having the corresponding major channel number display the streaming text data. Accordingly, it can be seen that, for example, virtual channels 7-1 and 7-2 corresponding to the major channel 7 display the streaming text data having the ID “B” as shown in FIG. 2A.

Streaming text data having a streaming text ID “C” has (9, 0), in which a number ‘9’ represents the major channel number and a number ‘0’ represents the minor channel number. At this time, the minor channel number is ‘0’, which represents that, among the virtual channels in the physical channel, only channels having the corresponding major channel number display the streaming text data. Accordingly, it can be seen that, for example, a virtual channel 9-3 corresponding to the major channel 9 displays the streaming text data having the ID “C” as shown in FIG. 2A.

Streaming text data having a streaming text ID “D” has (9, 3), in which a number ‘9’ represents the major channel number and a number ‘3’ represents the minor channel number. That is, it can be seen that the virtual channel 9-3 displays the streaming text data having the ID “D”.

Streaming text data having a streaming text ID “E” has (7, 2), in which a number ‘7’ represents the major channel number and a number ‘7’ represents the minor channel number. That is, it can be seen that the virtual channel 7-2 displays the streaming text data having the ID “E”.

Streaming text data having a streaming text ID “F” has (0, 0), in which a number ‘0’ represents the major channel number and a number ‘0’ represents the minor channel number. In this case, both the major channel number and the minor channel number are ‘0’. As described above, it can be seen that all the virtual channels in the physical channel display the streaming text data when both the major channel number and the minor channel number are ‘0’. Accordingly, it can be seen that all the virtual channels 7-1, 7-2 and 9-3 display the streaming text data having the ID “F” as shown in FIG. 2A.

A channel for displaying each streaming text will be described with reference to FIG. 2B. In FIG. 2B, the major channel number and the program number are combined in order to provide information on the channel for displaying each streaming text data.

Streaming text data having a streaming text ID “A” has (7, 1), in which a number ‘7’ represents the major channel number and a number ‘1’ represents the program number. That is, it can be seen that, among virtual channels having a major channel number of ‘7’ in a physical channel, a virtual channel having a program number of ‘1’ displays the streaming text data having the ID “A”.

Streaming text data having a streaming text ID “B” has (7, 0), in which a number ‘7’ represents the major channel number and a number ‘0’ represents the program number. At this time, the program number is ‘0’, which represents that all program numbers are included. That is, it is indicated that, among the virtual channels in the physical channel, virtual channels having the corresponding major channel number display the streaming text data regardless of the program number. Accordingly, it can be seen that, for example, virtual channels 7(1) and 7(2) corresponding to the major channel 7 display the streaming text data having the ID “B” as shown in FIG. 2B.

Streaming text data having a streaming text ID “C” has (9, 0), in which a number ‘9’ represents the major channel number and a number ‘0’ represents the program number. At this time, the program number is ‘0’, which represents that all program numbers are included. That is, it is indicated that, among the virtual channels in the physical channel, virtual channels having the corresponding major channel number display the streaming text data regardless of the program number. Accordingly, it can be seen that, for example, a virtual channel 9(3) corresponding to the major channel 9 displays the streaming text data having the ID “C” as shown in FIG. 2B. Although one virtual channel having the major channel number of ‘9’ is shown in FIG. 2B, all the virtual channels having the major channel number of ‘9’ display the streaming text data having the ID “C” regardless of the program number.

Streaming text data having a streaming text ID “D” has (9, 3), in which a number ‘9’ represents the major channel number and a number ‘3’ represents the program number. That is, it can be seen that, among virtual channels having a major channel number of ‘9’ in a physical channel, a virtual channel having a program number of ‘3’ displays the streaming text data having the ID “D”.

Streaming text data having a streaming text ID “E” has (7, 2), in which a number ‘7’ represents the major channel number and a number ‘2’ represents the program number. That is, it can be seen that, among virtual channels having a major channel number of ‘7’ in a physical channel, a virtual channel having a program number of ‘2’ displays the streaming text data having the ID “E”.

Streaming text data having a streaming text ID “F” has (0, 0), in which a number ‘0’ represents the major channel number and a number ‘0’ represents the program number. In this case, both the major channel number and the minor channel number are ‘0’. As described above, it can be seen that all the virtual channels in the physical channel display the streaming text data regardless of the program number when both the major channel number and the program number are ‘0’. Accordingly, it can be seen that all the virtual channels 7-1, 7-2 and 9-3 display the streaming text data having the ID “F” as shown in FIG. 2B.

A channel for displaying each streaming text will be described with reference to FIG. 2C. In FIG. 2C, the major channel number, the minor channel number and the program number are combined in order to provide information on the channel for displaying each streaming text data.

Streaming text data having a streaming text ID “A” has (7, 1, 1), in which a first number ‘7’ represents the major channel number, a second number ‘1’ represents the minor channel number, and a third number ‘1’ represents the program number. That is, it can be seen that, among virtual channels 7-1 in a physical channel, a virtual channel having a program number of ‘1’ displays the streaming text data having the ID “A”.

Streaming text data having a streaming text ID “B” has (7, 0, 0), in which a first number ‘7’ represents the major channel number, a second number ‘0’ represents the minor channel number, and a third number ‘0’ represents the program number. At this time, the minor channel number is ‘0’ which represents that all minor channels are included, and the program number is ‘0’ which represents that all program numbers are included. That is, it is indicated that, among the virtual channels in the physical channel, virtual channels having the corresponding major channel number display the streaming text data regardless of the minor channel number and the program number. Accordingly, it can be seen that, for example, virtual channels 7-1(1) and 7-2(2) corresponding to the major channel 7 display the streaming text data having the ID “B” as shown in FIG. 2C.

Streaming text data having a streaming text ID “C” has (9, 0, 0). This streaming text data is different from the streaming text data having the streaming text ID “B” in that the major channel number is changed from ‘7’ to ‘9’ and thus the description of the streaming text data having the streaming text ID “B” will be cited with respect to the portion except for the different portion. Accordingly, it can be seen that, for example, a virtual channel 9-3(3) corresponding to the major channel 9 displays the streaming text data having the ID “C” as shown in FIG. 2C. At this time, although one virtual channel having the major channel number of ‘9’ is shown in FIG. 2C, all the virtual channels having the major channel number of ‘9’ display the streaming text data having the ID “C” regardless of the minor channel number and the program number.

Streaming text data having a streaming text ID “D” has (9, 3, 3), in which a first number ‘9’ represents the major channel number, a second number ‘3’ represents the minor channel number, and a third number ‘3’ represents the program number. That is, it can be seen that, among virtual channels 9-3 in a physical channel, a virtual channel having a program number of ‘3’ displays the streaming text data having the ID “D”.

Streaming text data having a streaming text ID “E” has (7, 2, 2), in which a first number ‘7’ represents the major channel number, a second number ‘2’ represents the minor channel number, and a third number ‘2’ represents the program number. That is, it can be seen that, among virtual channels 7-2 in the physical channel, a virtual channel having a program number of ‘2’ displays the streaming text data having the ID “E”.

Streaming text data having a streaming text ID “F” has (0, 0, 0), in which a first number ‘0’ represents the major channel number, a second number ‘0’ represents the minor channel number, and a third number ‘0’ represents the program number. In this case, all the major channel number, the major channel number and the minor channel number are ‘0’. As described above, it can be seen that all the virtual channels in the physical channel display the streaming text data regardless of the program number when both the major channel number and the program number are ‘0’. Accordingly, it can be seen that all the virtual channels 7-1(1), 7-2(2) and 9-3(3) display the streaming text data having the ID “F” as shown in FIG. 2C.

Next, the actual streaming text data is contained. The streaming text data indicates additional information other than basic broadcasting information, that is, additional information necessary for a user, as described above. The streaming text data contained in the STT can use a multiple string structure (MSS) and a multilingual text string format (MTS). The MSS is used for transmitting an event title, a long channel name, and an extended text table (ETT) message to the PSIP for terrestrial and cable and the MTS is used for transmitting the name of an out-of-band (OOB) system information (SI) channel. The MSS and MTS may be used for transmitting the streaming text data.

Referring to FIG. 1, the “streaming_text_length” is a 16-bit field that represents the length of the “streaming_text( )” field that follows. The “streaming_text( )” field is a variable-bit field that defines the streaming text data using the MSS and the MTS.

Finally, the trailer will be described. A “CRC_{—}32” field is a 32-bit field containing a cyclic redundancy check (CRC) for guaranteeing a zero output from a register in a decoder defined in an MPEG-2 system after processing the whole streaming text table section.

Up to now, the streaming text table for transmitting/receiving the streaming text data was described. Accordingly, a transmitter/receiver can transmit/receive and process streaming text data using the streaming text table and provide the streaming text data to a user even in digital broadcasting. The user can obtain useful information in addition to basic broadcasting content.

(2) Apparatus for Processing Digital Television Signal

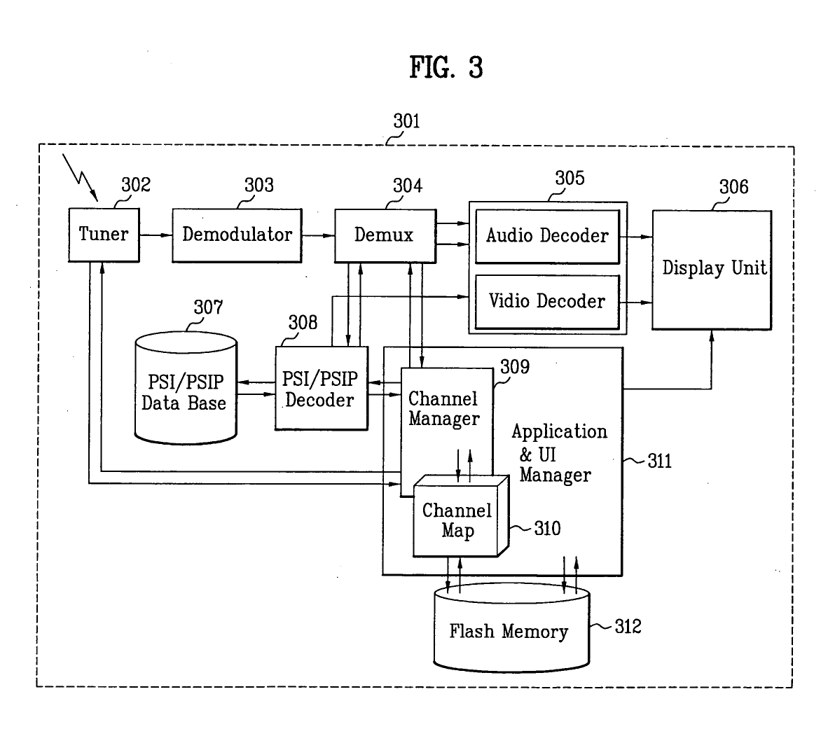

FIG. 3 is a block diagram of an exemplary digital television (DTV) receiver for processing a DTV signal containing a streaming text table.

The DTV receiver 301 includes a tuner 302, a demodulator 303, a demultiplexer 304, an audio/video (A/V) decoder 305, a display 306, a program specific information/program and system information protocol (PSI/PSIP) database 307, a PSI/PSIP decoder 308, a channel manager 309, a channel map 310, an application and user interface (UI) manager 311, and a flash memory 312.

The tuner 302 receives and tunes a DTV signal. The tuned DTV signal contains, for example, a streaming text table containing streaming text data. The tuner 302 is controlled by the channel manager 309 such that the result of the received digital television signal is recorded in the channel manager 309.

The demodulator 303 receives and demodulates the tuned signal into a vestigal side band/enhanced vestigal side band (VSB/EVSB) signal.

The demultiplexer 304 demultiplexes audio, video, and PSI/PSIP table information from demodulated transport packets. The demultiplexing of the PSI/PSIP table data is controlled by the PSI/PSIP decoder 308 and the demultiplexing of the audio and video is controlled by the channel manager 309. When the PSI/PSIP decoder 308 sets a packet identifier (PID) for a specific table as a condition, the demultiplexer 304 filters the sections of the PSI/PSIP table for satisfying the PID and transmits the sections to the PSI/PSIP decoder 308. When the channel manager 309 sets an A/V PID of a specific virtual channel as a condition, the demultiplexer 304 demultiplexes an A/V elementary stream (ES) and transmits the demultiplexed A/V ES to the A/V decoder 305.

The A/V decoder 305 receives and decodes the demultiplexed A/V ES.

The PSI/PSIP decoder 308 parses the filtered PSI/PSIP table and reads and records actual section data in the PSI/PSIP database 307.

The channel manager 309 requests the reception of a channel-related information table by referring to the channel map 310 and receives the result. At this time, the PSI/PSIP decoder 308 controls the demultiplexer 304 to filter the channel-related information table, parses the filtered channel-related information table, and transmits a list of A/V PIDs to the channel manager 309. The channel manager 309 may directly control the demultiplexer 304 using the received A/V PID to control the A/V decoder 305.

The application and UI manager 311 controls a graphical user interface (GUI) for displaying the state of the receiver with an on-screen display (OSD).

In particular, the demultiplexer 304 can check only the header of the table transmitted from the broadcasting station using the PID, the table identification, the version number, the section number, and the table identification extension. That is, the demultiplexer 304 can filter a streaming text table section using the header as described above. The PSI/PSIP decoder 308 receives and parses the filtered streaming text table from the demultiplexer 304. At this time, the streaming text table has the configuration shown in FIG. 1. The PSI/PSIP decoder 308 stores information about the streaming text data in the parsed streaming text table in the PSI/PSIP database 307.

The display 306 displays the streaming text data stored in the PSI/PSIP database 307 under the control of the application and UI manger 311.

(3) Method for Processing Digital Television Signal Containing Streaming Text Table

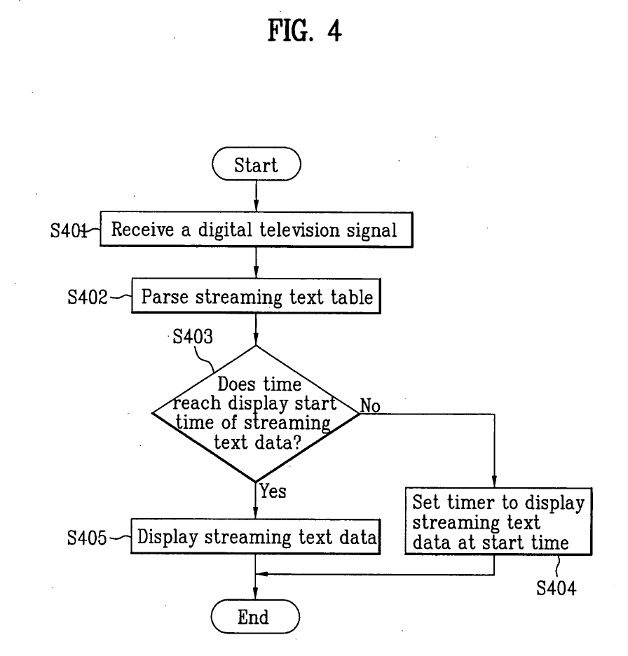

Hereinafter, a method for processing a digital television (DTV) signal containing a streaming text table for transmitting/receiving streaming text data using the above-described DTV receiver will be described. FIG. 4 is an exemplary flowchart of a method for processing a DTV signal containing a streaming text table

First, a DTV signal is received. At this time, the DTV signal contains a streaming text table for transmitting/receiving streaming text data.

The received DTV signal is demodulated and demultiplexed and a streaming text table section is filtered (S401). At this time, a master guide table (MGT) having the PIDs of all tables except for a system time table is filtered and parsed and the PID of the streaming text table is set in the demultiplexer 304 as a condition such that only the streaming text table section can be filtered.

The DTV receiver parses the filtered streaming text table is parsed (S402). At this time, the streaming text table has the configuration shown in FIG. 1.

Information on the streaming text data within the parsed streaming text table is stored in the PSI/PSIP database 307. At this time, the information on the stored streaming text data contains information for identifying streaming text data, information on a display start time and duration, information on a display channel, and actual streaming text data information.

Accordingly, the DTV receiver extracts the information on the display start time from the information on the stored streaming text data and determines whether a time reaches the extracted start time (S403).

If it is determined that the time does not reach the display start time of the streaming text data, a timer is set and information on the rest of the stored streaming text data is extracted and displayed at the start time of the set timer (S404).

In contrast, if it is determined that the time reaches the display start time of the streaming text data, the information on the rest of the stored streaming text data is extracted and displayed (S405). That is, the channel displays actual streaming text data for the display duration. With respect to the detailed contents of the display, the above description will be cited.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of processing a digital television signal in a digital television receiver, the method comprising:
receiving a digital television signal including a streaming text table carrying streaming text data representing additional information transmitted from a transmitter;
parsing the streaming text table, the parsed streaming text table including display information specifying an information type, display time, and display channel associated with the streaming text data; and
displaying the streaming text data according to the display information.

2. The method of claim 1, wherein the information type of the streaming text data indicates any one of advertisement, stock, weather, news, and traffic.

3. The method of claim 1, wherein the display time of the streaming text data specifies a display start time and duration of the streaming text data.

4. The method of claim 3, wherein the display start time of the streaming text data are in global positioning system (GPS) second.

5. The method of claim 3, wherein the duration of the streaming text data are in seconds.

6. The method of claim 1, wherein the display information specifies a major channel number and minor channel number representing the display channel.

7. The method of claim 6, wherein the display information further specifies a program number.

8. The method of claim 1, wherein a format of the streaming text data is any one of multiple string structure (MSS) and multilingual text string (MTS).

9. A digital television receiver, comprising:
a tuner arranged to receive a digital television signal;
a demodulator arranged to demodulate the digital television signal;
a demultiplexer arranged to demultiplex a streaming text table from the demodulated digital television signal including the streaming text table carrying streaming text data representing additional information transmitted from a transmitter;
a decoder arranged to parse the streaming text table, the parsed streaming text table comprising display information specifying an information type, display time, and display channel associated with the streaming text data;
a display unit arranged to display the parsed streaming text data according to the display information; and
a controller arranged to control operation of the decoder and the display unit.

10. The receiver of claim 9, wherein the controller extracts a display start time and duration of streaming text data.

11. The receiver of claim 10, wherein the controller determines whether the display start time of the streaming text data is passed.

12. The receiver of claim 11, wherein the controller controls the decoder to set timer for displaying the streaming text data on time if the display start time of the streaming text data is not passed.

13. The receiver of claim 10, wherein the controller determines whether the duration of the streaming text data is passed.

14. The receiver of claim 9, wherein the controller extracts a display channel information of the streaming text data.

15. The receiver of claim 14, wherein the display channel information of the streaming text data specifies a major channel number and minor channel number representing the display channel.

16. The receiver of claim 15, wherein the display channel information of the streaming text data further specifies a program number.
